(19) United States
(12) Patent Application Publication
(10) Pub. No.: US 2024/0078087 A1
(43) Pub. Date: Mar. 7, 2024

(54) METHOD AND APPARATUS FOR UNIFIED DYNAMIC AND/OR MULTIBIT STATIC ENTROPY GENERATION INSIDE EMBEDDED MEMORY

(71) Applicant: NATIONAL UNIVERSITY OF SINGAPORE, Singapore (SG)

(72) Inventors: Sachin TANEJA, Singapore (SG); Viveka KONANDUR RAJANNA, Singapore (SG); Massimo ALIOTO, Singapore (SG)

(73) Assignee: NATIONAL UNIVERSITY OF SINGAPORE, Singapore (SG)

(21) Appl. No.: 18/262,479

(22) PCT Filed: Dec. 23, 2021
(86) PCT No.: PCT/SG2021/050820

§ 371 Date: Jul. 21, 2023

(30) Foreign Application Priority Data
Jan. 22, 2021 (SG) 10202100753U

(51) Int. Cl. G06F 7/58; G11C 7/24; G11C 11/418; H04L 9/32

(52) U.S. Cl. CPC G06F 7/588; G11C 7/24; G11C 11/418; H04L 9/3278

(57) ABSTRACT

Embedded memory structures and methods where an array of bitcells is interconnected by a plurality of bitlines and wordlines, each bitcell comprising a transistor connected to one of the wordlines and one of the bitlines. A TRNG circuit, peripheral to the array of bitcells, sets transistors connected to the one or more of the bitlines to an off state, determines a time interval between different crossing thresholds in a voltage discharge in the bitlines, and digitizes the time interval into bits of an TRNG output. A PUF circuit. peripheral to the array of bitcells, sets a pair of transistors connected to the pair of bitlines and the same wordline to an underdriven state, determines respective times of the transistors of the pair crossing a threshold in a voltage discharge in the pair of bitlines, and digitizes a time difference into an n-bit PUF output.

### CROSS-REFERENCE TO RELATED APPLICATION

This application claims the benefit of priority of Singapore Patent Application No. 10202100753U filed on Jan. 22, 2021, the content of which is incorporated herein by reference in its entirety for all purposes.

### FIELD OF INVENTION

The present invention relates broadly to an embedded memory (e.g., static random access memory (SRAM), dynamic RAM (DRAM), read only memory (ROM), and flash memory) structure and to a method of fabricating an embedded memory structure, in particular to in-memory unified dynamic (i.e., true random number generator (TRNG)) and/or multibit static (i.e., physically unclonable function (PUF)) entropy generation for ubiquitous hardware security.

### BACKGROUND

Any mention and/or discussion of prior art throughout the specification should not be considered, in any way, as an admission that this prior art is well known or forms part of common general knowledge in the field.

Random keys generation is a foundational task in the chain of trust of connected systems, and in security protocols for device authentication, in-transit data confidentiality and integrity assurance etc. Hardware-secure data handling and exchange invariably requires on-chip generation of random keys with dynamic and static entropy enabled by true random number generators (TRNGs) and physically unclonable functions (PUFs).

Enabling truly ubiquitous security requires the embedment of key generation even in low-cost and tightly-constrained edge devices, mandating aggressive reductions in area, design effort and power. The pursuit of such reductions has led to architectures of security primitives that are unified with other functions to enable circuit reuse (e.g., TRNG with ADC, TRNG with PUF, cryptographic core with TRNG), or embedded in memory (e.g., SRAM PUFs), or inherently immersed-in-logic. Such architectures offer the additional benefit of suppressing obvious points of physical attacks such as voltage probing, compared to standalone primitives.

Although the ubiquitous availability of SRAMs and their low design effort via memory compilers have been widely exploited to embed PUFs in commercial chips, such in-memory primitives do not include a TRNG. Hence, they support only part of the key generation sub-system. Also, extracting entropy from most of SRAM PUF bitcells within the same array routinely imposes stringent PUF stability requirements, additional area and power for stability enhancement (e.g., more than doubled bitcell area). This is largely due to the common restriction of one bit per bitcell in conventional SRAM PUFs relying on the natural bitcell state at power-up, which has been removed in some recent non-SRAM PUFs with multibit per PUF bitcell.

Embodiments of the present invention seek to address at least one of the above problems.

### SUMMARY

In accordance with a first aspect of the present invention, there is provided an embedded memory structure comprising:
an array of bitcells interconnected by a plurality of bitlines and a plurality of wordlines, each bitcell comprising a transistor connected to one of the wordlines and one of the bitlines; and
a true random number generator, TRNG, circuit peripheral to the array of bitcells, with an input of the TRNG circuit coupled to one or more of the bitlines;
wherein the TRNG circuit is configured to
   set transistors connected to the one or more of the bitlines to an off state,
   to determine a time interval between different crossing thresholds in a voltage discharge in the one or more bitlines, and
   to digitize the time interval into bits of an TRNG output.

In accordance with a second aspect of the present invention, there is provided an embedded memory structure comprising:
an array of bitcells interconnected by a plurality of bitlines and a plurality of wordlines, each bitcell comprising a transistor connected to one of the wordlines and one of the bitlines; and
a physically unclonable function, PUF, circuit peripheral to the array of bitcells, with an input of the PUF circuit coupled to one or more pairs of bitlines;
wherein the PUF circuit is configured to
   set a pair of transistors connected to respective ones of the pair of bitlines and to the same wordline to an underdriven state,
   to determine respective times, t_{A}, t_{B}, of the transistors of the pair crossing a threshold in a voltage discharge in the pair of bitlines, and
   to digitize a difference between t_{A} and t_{B} into an n-bit PUF output, wherein n is an integer ≥2.

In accordance with a third aspect of the present invention, there is provided an embedded memory structure comprising:
an array of bitcells interconnected by a plurality of bitlines and a plurality of wordlines, each bitcell comprising a transistor connected to one of the wordlines and one of the bitlines; and
a true random number generator, TRNG, circuit peripheral to the array of bitcells, with an input of the TRNG circuit coupled to one or more of the bitlines;
wherein the TRNG circuit is configured to
   set transistors connected to a one of said one or more of the bitlines to an off state,
   to determine a time interval between different crossing thresholds in a voltage discharge in the one or more bitlines, and
   to digitize the time interval into bits of an TRNG output;
a physically unclonable function, PUF, circuit peripheral to the array of bitcells, with an input of the PUF circuit coupled to one or more pairs of bitlines;
wherein the PUF circuit is configured to
   set a pair of transistors connected to respective ones of the pair of bitlines and to the same wordline to an underdriven state,
   to determine respective times, t_{A}, t_{B}, of the transistors of the pair crossing a threshold in a voltage discharge in the pair of bitlines, and
   to digitize a difference between t_{A} and t_{B} into an n-bit PUF output, wherein n is an integer ≥2.

In accordance with a fourth aspect of the present invention, there is provided a method of fabricating an embedded memory structure comprising the steps of:
providing an array of bitcells interconnected by a plurality of bitlines and a plurality of wordlines, each bitcell comprising a transistor connected to one of the wordlines and one of the bitlines;
providing a true random number generator, TRNG, circuit peripheral to the array of bitcells, with an input of the TRNG circuit coupled to one or more of the bitlines; and
configuring the TRNG peripheral circuit to
   set transistors connected to the one or more of the bitlines to an off state,
   to determine a time interval between different crossing thresholds in a voltage discharge in the one or more bitlines, and
   to digitize the time interval into bits of an TRNG output.

In accordance with a fifth aspect of the present invention, there is provided a method of fabricating an embedded memory structure comprising the steps of:
providing an array of bitcells interconnected by a plurality of bitlines and a plurality of wordlines, each bitcell comprising a transistor connected to one of the wordlines and one of the bitlines;
providing a physically unclonable function, PUF, circuit peripheral to the array of bitcells, with an input of the PUF circuit coupled to one or more pairs of bitlines; and
configuring the PUF circuit to
   set a pair of transistors connected to the pair of bitlines and to the same wordline within respective columns to an underdriven state,
   to determine respective times, t_{A}, t_{B}, of the transistors of the pair crossing a threshold in a voltage discharge in the pair of bitlines, and
   to digitize a difference between t_{A} and t_{B} into an n-bit PUF output, wherein n is an integer ≥2.

In accordance with a sixth aspect of the present invention, there is provided a method of fabricating an embedded memory structure comprising the steps of:
providing an array of bitcells interconnected by a plurality of bitlines and a plurality of wordlines, each bitcell comprising a transistor connected to one of the wordlines and one of the bitlines;
providing a true random number generator, TRNG, circuit peripheral to the array of bitcells, with an input of the TRNG circuit coupled to one or more of the bitlines;
configuring the TRNG circuit to
   set transistors connected to the one or more of the bitlines to an off state,
   to determine a time interval between different crossing thresholds in a voltage discharge in the one or more bitlines, and
   to digitize the time interval into bits of an TRNG output.

Providing a physically unclonable function, PUF, circuit peripheral to the array of bitcells, with an input of the PUF circuit coupled to one or more pairs of adjacent bitlines; and
configuring the PUF circuit to
   set a pair of transistors connected to the pair of bitlines and the same wordline to an underdriven state,
   to determine respective times, t_{A}, t_{B}, of the transistors of the pair crossing a threshold in a voltage discharge in the pair of bitlines, and
   to digitize a difference between t_{A} and t_{B} into an n-bit PUF output, wherein n is an integer ≥2.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating an in-memory unified entropy source (SRAM with TRNG and PUF) for secure system on chip (SoC), according to an example embodiment.

FIG. 2 shows a schematic drawing illustrating the working principle of in-memory dynamic entropy generation (TRNG), according to an example embodiment.

FIG. 3 shows a schematic drawing illustrating the working principle of in-memory static entropy generation (PUF), according to an example embodiment.

FIG. 4 shows a schematic drawing illustrating the column peripheral circuitry for dynamic (TRNG) and multibit static (PUF) entropy digitization, as respectively based on a gated ring oscillator (RO)-based time-to-digital converter (TDC) and a delay line-based TDC, according to an example embodiment.

FIG. 5(a) shows a schematic drawing illustrating the dynamic entropy digitization using RO-based TDC with temperature compensation and frequency adaptation to keep TRNG power within a range, according to an example embodiment.

FIG. 5(b) shows the waveform of dynamic entropy generation and digitization (TRNG), according to an example embodiment.

FIG. 6(a) shows a schematic drawing illustrating the multibit static entropy digitization using delay line-based TDC, according to an example embodiment.

FIG. 6(b) shows a schematic drawing illustrating waveform of multibit static entropy generation and digitization (PUF), according to an example embodiment.

FIG. 7 shows an annotated image of a 28-nm CMOS die micrograph and measurement setup block diagram, according to an example embodiment.

FIG. 8(a) shows a graph illustrating the measured TRNG output entropy versus supply voltage V_{DD} at worst-case temperature of 100° C., according to an example embodiment.

FIG. 8(b) shows a graph illustrating the measured TRNG output entropy versus temperatures at different data patterns stored in bitcells connected to the bitline, according to an example embodiment.

FIG. 9 shows a graph illustrating the measured TRNG output entropy versus joint worst-case conditions on V_{DD} and temperature at different data patterns, according to an example embodiment.

FIG. 10(a) shows a graph illustrating the measured TRNG energy and RO frequency versus temperature without tuning loop (V_{DD}=0.75 V at different data patterns), according to an example embodiment.

FIG. 10(b) shows a graph illustrating the measured TRNG energy and RO frequency versus temperature with tuning loop (V_{DD}=0.75 V at different data patterns), according to an example embodiment.

FIG. 11(a) shows a graph illustrating the speckle diagram of measured TRNG output at worst-case condition (V_{DD}=0.75 V and 100° C.), according to an example embodiment.

FIG. 11(b) shows a graph illustrating the autocorrelation function (ACF) of measured TRNG output at worst-case condition (V_{DD}=0.75 V and 100° C.), according to an example embodiment.

FIG. 12 shows a graph illustrating the statistical analysis of multiple output bitstreams in terms of correlation at worst-case condition (V_{DD}=0.75 V and 100° C.), according to an example embodiment.

FIG. 13 shows a graph illustrating the measured TRNG output entropy resilience against power supply injection attacks with 0.3−Vₚ₋ₚ sine wave superimposed to V_{DD}=0.9 V at the worst-case −25° C. temperature vs. its frequency (multiple of measured RO frequency of 84.5 MHz) at different data patterns, according to an example embodiment.

FIG. 14(a) shows a graph illustrating the PUF output stability against golden key at nominal conditions (V_{DD}=0.9 V, 25° C., 0% Hamming distance HD in pair of adjacent bitlines) versus number of repeated evaluations, according to an example embodiment.

FIG. 14(b) shows a graph illustrating the PUF output stability against golden key at nominal conditions (V_{DD}=0.9 V, 25° C., 0% Hamming distance HD in pair of adjacent bitlines) versus temperature (V_{DD}=0.9 V, 500 evaluations, 0% HD), according to an example embodiment.

FIG. 14(c) shows a graph illustrating the PUF output stability against golden key at nominal conditions (V_{DD}=0.9 V, 25° C., 0% Hamming distance HD in pair of adjacent bitlines) versus supply voltage V_{DD} (25° C., 500 evaluations, 0% HD), according to an example embodiment.

FIG. 14(d) shows a graph illustrating the PUF output stability against golden key at nominal conditions (V_{DD}=0.9 V, 25° C., 0% Hamming distance HD in pair of adjacent bitlines) versus HD in pair of adjacent bitlines (V_{DD}=0.9 V, 25° C., 500 evaluations), according to an example embodiment.

FIG. 15 shows a graph illustrating the PUF stability versus joint worst-case conditions across V_{DD}, temperatures and HD in pair of adjacent bitlines with 500 evaluations against golden key at nominal conditions (V_{DD}=0.9 V, 25° C., 0% Hamming distance HD in pair of adjacent bitlines), according to an example embodiment.

FIG. 16 shows a graph illustrating the measured Shannon entropy of multibit PUF output versus delay line variations at nominal conditions (V_{DD}=0.9 V and 25° C.) according to an example embodiment.

FIG. 17 shows a graph illustrating the speckle diagram and independence of measured PUF[0] and PUF[1] output at nominal conditions (V_{DD}=0.9 V and 25° C.) according to an example embodiment.

FIG. 18(a) shows a graph illustrating the measured intra-die and inter-die PUF Hamming distance of PUF[0] and PUF[1] output at nominal conditions, according to an example embodiment.

FIG. 18(b) shows a graph illustrating the autocorrelation function (ACF) of PUF[0] and PUF[1] output at nominal conditions, according to an example embodiment.

FIG. 19(a) shows a graph illustrating the measured PUF[0] bias along SRAM columns (i.e., 256 rows) at nominal conditions, according to an example embodiment.

FIG. 19(b) shows a graph illustrating the measured PUF[1] bias along SRAM columns (i.e., 256 rows) at nominal conditions, according to an example embodiment.

FIG. 20 shows a graph illustrating the measured impact of accelerated aging on PUF stability across operating conditions with 500 evaluations, according to an example embodiment.

FIG. 21(a) shows a graph illustrating the SRAM write performance versus V_{DD} (25° C.), according to an example embodiment.

FIG. 21(b) shows a graph illustrating the SRAM read performance versus V_{DD} (25° C.), according to an example embodiment.

FIG. 21(c) shows a graph illustrating the TRNG access performance versus temperature (V_{DD}=0.75 V), according to an example embodiment.

FIG. 21(d) shows a graph illustrating the PUF access performance versus V_{DD} (25° C.), according to an example embodiment.

FIG. 22 shows a flowchart illustrating a method of fabricating an embedded memory structure, according to an example embodiment.

FIG. 23 shows a flowchart illustrating a method of fabricating an embedded memory structure, according to an example embodiment.

FIG. 24 shows a flowchart illustrating a method of fabricating an embedded memory structure, according to an example embodiment.

### DETAILED DESCRIPTION

An example embodiment of the present invention provides an SRAM (as a non-limiting example of an embedded memory) architecture with in-memory generation of both dynamic (TRNG) and multibit static (PUF) entropy generation. This inexpensively extends complete key generation capabilities to any system that includes an embedded memory, e.g. SRAM, and hence enables incorporation of complete key generation capabilities down to tightly-constrained and very low-cost devices. The array according to an example embodiment embeds a TRNG and a PUF, while using a commercial bitcell and periphery all-digital pitch-matched augmentation to retain the simplicity of memory compiler designs.

In an example embodiment, TRNG bits are generated from bitline discharge induced by the cumulative column-level leakage, whose otherwise exponential energy increase under temperature fluctuations is counteracted by an energy control loop. Multiple PUF bits (e.g., 2 bits) per accessed bitcell are uniquely extracted from the bitline discharge rate, rather than conventional power-up state. A 16-kb SRAM array in 28 nm process technology node according to an example embodiment shows cryptographic-grade TRNG operation at the low area cost of 12.5 μm² per output stream, and 2-bit/PUF bitcell with 12.6 Gbps and 72 fJ/bit energy. Embedment within the array and inherent data locality advantageously eliminate obvious physical attack points of standalone TRNGs and PUFs.

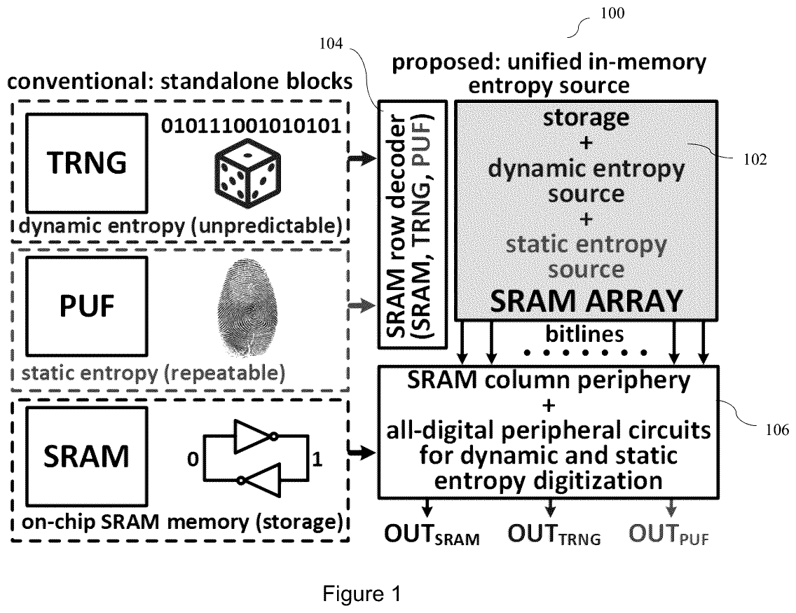

An SRAM structure 100 with unified TRNG and multibit PUF for complete in-memory dynamic and static entropy generation can be provided according to an example embodiment for low-cost and ubiquitous security, both in terms of low area, low design and system integration effort as shown in FIG. 1. As a TRNG, no calibration is needed to maintain cryptographic-grade keys across voltages and temperatures. When used as a PUF, the multibit/bitcell capability improves PUF density and relaxes its stability requirement for a targeted PUF capacity. As opposed to conventional power-up state-based SRAM PUFs, no intermediate bank flushing is needed, allowing uninterrupted SRAM usage. The bitline discharge rate digitization principle adopted in this work is fully digital and relies on the sole augmentation of the periphery of the SRAM array 102. This permits full reuse of commercial bitcells and memory compiler-based automated design. Extensive reuse of most SRAM array infrastructure in implementing the SRAM row decoder 104 and the SRAM peripheral circuitry 106 allows the inclusion of the complete key generation sub-system at 12.7% area overhead over a baseline SRAM.

### Working Principle of Unified Dynamic and Multibit Static Entropy Generation According to an Example Embodiment

In an example embodiment, the random behavior of the bitline discharge rate is used as common principle, alternatively relying on leakage-induced temporal noise for TRNG, or chip-specific local variations of the read current for PUF. Between the two, the dominant behavior is selected by simply biasing the wordline at run time with no need for accurate voltage generation. The application of this principle to generate dynamic (static) entropy is described in detail below.

### Dynamic Entropy Generation (TRNG) According to an Example Embodiment

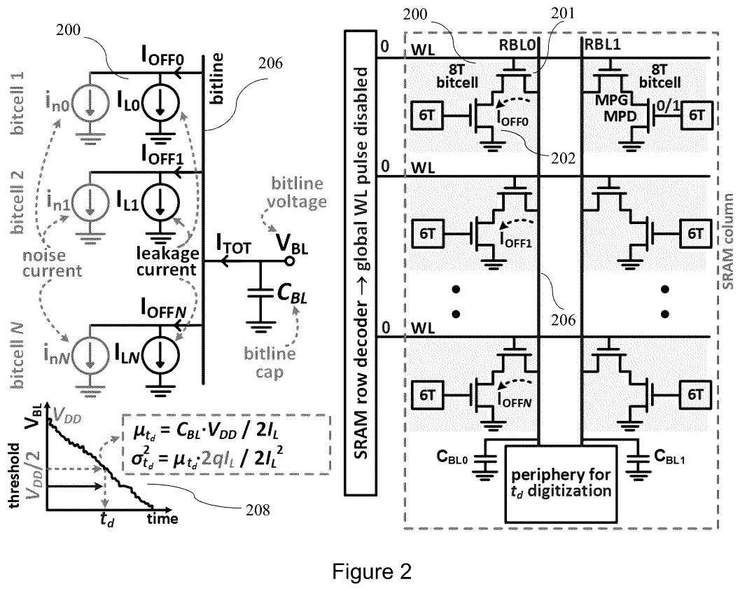

The digitization of the bitline discharge rate can be applied to generate dynamic entropy according to an example embodiment by harvesting the inherently large random noise accumulated throughout the bitline capacitance discharge process under very low transistor current. With reference to FIG. 2, to avoid the need for any accurate transistor biasing, the leakage current provided by the SRAM bitcell e.g. 200 access or pass-gate 201 and pull-down or driver transistor 202, respectively (i.e., two-transistor read stack) is exploited in the following according to an example embodiment. As further benefit, the additive nature of the leakage and current noise contributions of bitcells e.g. 200 sharing the same bitline 206 allows to take full advantage of all bitcells at the same time, effectively combining multiple randomness sources into one.

The cumulative random noise harvested from one or more bitlines e.g. 206 translates into a discharge time with inherent timing jitter, as indicated in graph 208 in FIG. 2. To trigger leakage-driven discharge of the relevant bitline capacitance C_{BL}, the latter is precharged at the supply voltage V_{DD} and all wordlines are disabled. Then, C_{BL} is discharged by the cumulative bitline leakage current from all bitcells I_{L}, taking a time t_{d} to cross V_{DD}/2. t_{d} is a Wiener process (i.e., a continuous-time random process) that resembles a random walk without drift, as only random white Gaussian noise from the bitline leakage current is integrated during the capacitor discharge. The discharge time results to a Gaussian distribution with mean and variance equal to (1)-(3):

μₜ_{_{d}}=C_{BL}V_{DD}/2I_{L} (1)

σₜ_{_{d}}²=μₜ_{_{d}}·S_{I}_{_{L,n}}/2I_{L}² (2)

σₜ_{_{d}}²=μₜ_{_{d}}·q/I_{L} (3)
where S_{I}_{_{L,n}}=2qI_{L} (A²/Hz) is the power spectral density per unit bandwidth of the cumulative bitline leakage current noise source, and q is the electron charge. In (1)-(3), it was considered that the dominant noise source is the thermal or shot noise, when transistors conduct their leakage current.

From (3), the adoption of the lowest possible current (i.e., leakage) maximizes the value of μₜ_{_{d}} in (3) and hence the randomness associated with t_{d}, as quantified by its variance σₜ_{_{d}}² under a given bitline capacitance and supply voltage. In (3), all SRAM bitcells connected to the same bitline act as independent and uncorrelated noise sources, further improving randomness and hence dynamic entropy according to an example embodiment. Also, the undesirable flicker noise contribution (In a TRNG, flicker noise determines temporal noise correlation, hence “coloring” the output statistics of the output bitstream) is negligible compared to the above white noise contribution, since SRAM bitcell transistors e.g. 201, 202 in the read stack have minimal transconductance when conducting leakage.

Regarding the impact of process/voltage/temperature variations and SRAM data pattern, the worst-case randomness is obtained under the conditions that minimizes σₜ_{_{d}}² and hence μₜ_{_{d}} with the highest value of I_{L} (3), which occur at the maximum temperature and the minimum voltage within the operating range from (1)-(3). This also includes the linear increase in the power spectral density component of the cumulative bitline leakage current noise source (S_{I}_{_{L,n}}=2qI_{L}).

The randomness of the above jittered bitline discharge time is subsequently extracted by conversion to a pulsewidth and digitization via time-to-digital conversion according to an example embodiment, as is described below in more detail.

### Static Entropy Generation (PUF) According to an Example Embodiment

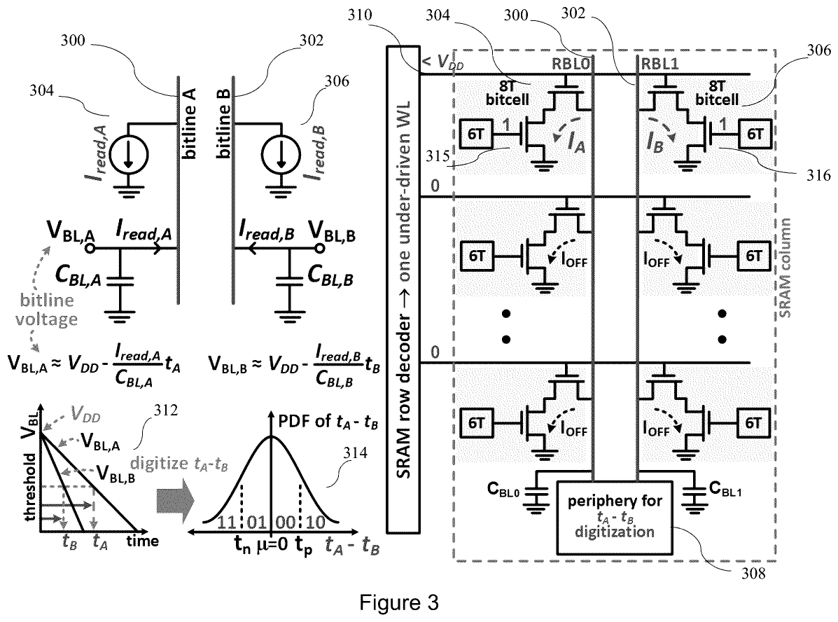

To generate static entropy as expected from a PUF under the same principle of bitline discharge rate according to an example embodiment, the bitline discharge rate is to be mismatch-dominated rather than noise-dominated as for the dynamic entropy (TRNG) generation. With reference to FIG. 3, this is achieved according to an example embodiment by evaluating the discharge time of a selected bitline pair 300, 302 under the mismatch-dependent read current difference of a selected bitcell pair 304, 306. The column periphery 308 is configured to emphasize the effect of local (i.e., intra-die) variations. It is noted that the bitcell pair does not have to be selected from immediately adjacent bitlines within column (e.g., bitlines in adjacent columns) in other example embodiments, provided that the characteristics of the selected bitcells can be expected to be similar, i.e. spatial process gradients are negligible between the selected bitcells within same or adjacent columns.

In detail, the bitlines 300, 302 are precharged, one wordline 310 is activated in the considered SRAM bank, and the bitline discharge time difference (t_{A}−t_{B}) is evaluated in a pair of horizontally adjacent bitcells 304, 306. The adjacency of the bitcells 304, 306 and their respective bitlines 300, 302 allows to make use of all bitcells, instead of only those selected by the column multiplexer in conventional read/write accesses. This eliminates the bitline energy waste that non-selected bitlines would inevitably consume anyway due to conventional pseudo-read, turning them into a useful static randomness source rather than leaving them unutilized. In a preferred embodiment, the physical adjacency of bitcell pairs 304, 306 being compared minimizes the effect of spatial process gradients.

The above bitline discharge time difference (t_{A}−t_{B}) illustrated in graph 312 and the resulting static randomness illustrated in graph 314 are inherently immune to common-mode effects such as global process variations, as well as voltage and temperature fluctuations. The resulting constant-current discharge process of C_{BL} under the read current I_{read} can be modeled as shown in FIG. 3, and leads to

σₜ_{_{A}}₋ₜ_{_{B}}²=2σₜ_{_{A}}²≈2σ_{I}_{_{read,A}}² (4)
where it was assumed that the read currents I_{read,A} and I_{read,B} in the bitcell pair 304, 306 are statistically uncorrelated for the above discussed reasons. The variability of the bitline discharge time ultimately depends on the individual contributions of I_{read} and C_{BL}. Variations in the read current I_{read} largely dominates over the variations in C_{BL} (i.e., wire variations). Monte Carlo simulations show a 25% variability in I_{read} at nominal conditions (0.9 V and 25° C.), and well below 1% variability in C_{BL}. Accordingly, variations in C_{BL} can be ignored in practical cases, and become even smaller in common larger arrays with longer bitlines and higher number of rows due to averaging effect, as per Pelgrom's law.

From a design viewpoint, from (4) the dominance of local variations can be further enforced by moderately under-driving the wordline (e.g., 20% less than V_{DD}) according to an example embodiment, which is also typically adopted in modern SRAM. Indeed, this further exacerbates the effect of local variations in the bitcell-specific access transistors. The above mechanism according to an example embodiment works correctly as long as both bitcells 304 and 306 lead to a deterministic bitline discharge with same polarity (e.g., falling transition), meaning that they store the same value (e.g., 0 in 6T within SRAM bitcells 304, 306 driving the pull-down transistor 315, 316 gate terminal to 1 in the two-transistor read stack as shown in FIG. 3, which determines I_{read,A} in bitcell 304 and I_{read,B} in bitcell 306). In other words, all the bitcells and array rows used for PUF output generation store the same value (i.e., 0 in 6T within SRAM bitcell). However, this still allows other rows to be used as address space for read/write access as conventional SRAMs without any data pattern restriction. This means that the proposed architecture allows the coexistence of PUF words and conventional bitcells even in the same bank, as long as the address space is explicitly partitioned. Instead, this is not allowed in conventional power-up state-based SRAM PUFs, in which the entire bank (or multiple banks) need to be flushed to restore the bitcell power-up in some words in it.

Interestingly, the mechanism according to an example embodiment is not restricted by the steady-state value set at the power-up, as it is transient in nature. This allows to extract multiple entropy bits per PUF bitcell by simply binning the time difference (t_{A}−t_{B}) into one of multiple time bins, as exemplified in graph 314 for two bits (i.e., four bins). Ultimately, such multibit source of static entropy according to an example embodiment can be digitized with a time-to-digital converter (TDC) as previously mentioned for the TRNG operation, and as discussed in depth below.

### Unified Dynamic and Static Entropy Digitization According to an Example Embodiment

The in-memory unified randomness generation according to an example embodiment described above ultimately leads to a random discharge time, which is digitized via time-to-digital conversion (TDC). Hence, a fully-digital TDC architecture is adopted according to an example embodiment to keep the overhead low and allow seamless integration with pitch-matched column-level periphery, advantageously preserving automated memory compiler-based designs.

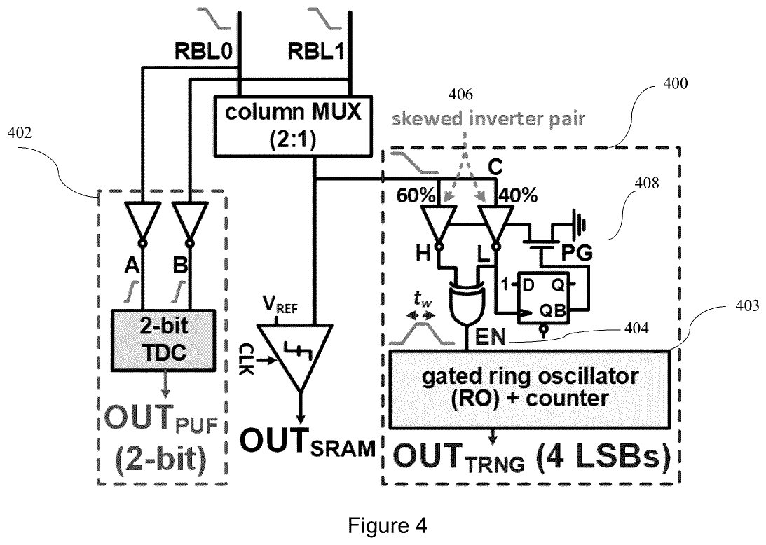

FIG. 4 shows the circuitry digitizing the bitline discharge time for both the TRNG (block 400) and the 2-bit per PUF bitcell (block 402) at every column. The remainder of the circuitry is fully shared among TRNG, PUF and SRAM storage, limiting the overhead over a conventional SRAM to the blocks 400, 402 in FIG. 4 at respective columns. These blocks 400, 402 are discussed in detail below. It is noted that the TRNG block 400 can be connected to one (i.e., selected) bitline via a column multiplexer(s) as shown in FIG. 4 or more bitlines bypassing the column multiplexer(s).

### Dynamic Entropy (TRNG) Digitization According to an Example Embodiment

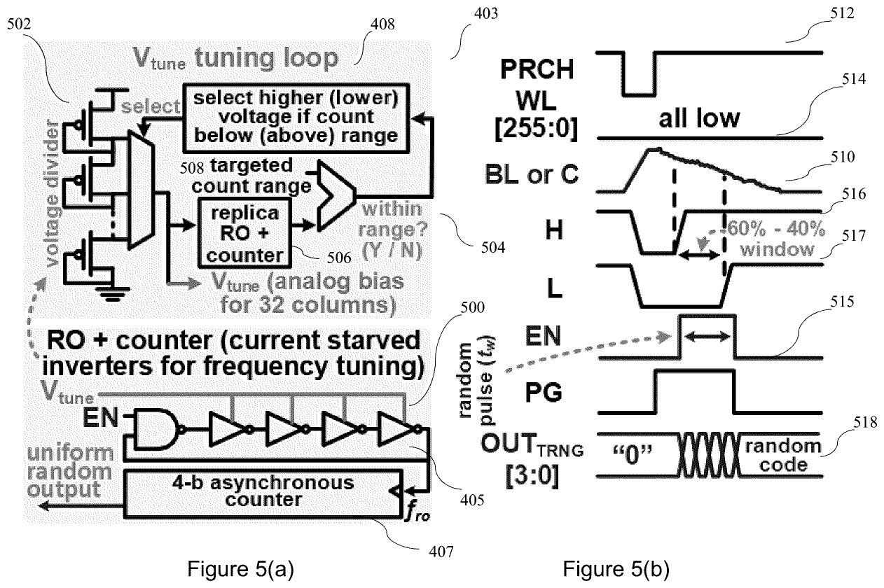

The TRNG digital output is generated by digitizing the jittered bitline discharge time due to leakage via a TDC block 403 based on gated ring oscillator (RO) and an asynchronous counter. RO in this herein refers to the conventional ring oscillator with enable pin EN 404 in the NAND gate, as shown in FIG. 4 and FIG. 5(a). The RO 405 generates a frequency ƒᵣₒ that clocks an asynchronous counter 407 working as a TDC, as shown in FIG. 4 and FIG. 5(a). The jitter a accumulated on a bitline discharge in (3) grows over time, and is converted into a random pulsewidth t_{w} starting when the bitline voltage V_{BL} crossed 60% of V_{DD}, and ending at 40% of V_{DD}. These thresholds are defined by the logic threshold of skewed inverter gates of a skewed inverter pair 406 working as continuous-time comparators. During the pulsewidth t_{w}, the same logic high output of the skewed inverter gates enables the oscillation of the RO 405, whose edges are counted to convert t_{w} to a digital output. The restriction of the RO 405 oscillations within the relatively small 60-40% interval in an example embodiment helps reduce its dominant energy consumption. To further improve the energy efficiency of the TRNG peripheral circuitry block 400, the skewed inverters 406 are power gated through a feedback loop 408 that disables them once the low-skewed inverter of the pair 406 experiences a rising transition, marking the end of the digitization process as in FIGS. 4 and 5(b).

It is noted that any time-to-digital converter may be used in different example embodiments.

The random pulsewidth t_{w} fluctuations due to transistor noise in (1)-(3) is Gaussian distributed due to the Gaussian nature of the underlying thermal or shot noise contributions, and also from the Gaussian increment property of Wiener processes (i.e., Wₜ_{_{d-40%}}−Wₜ_{_{d-60%}}, where Wₜ_{_{d-50%}} is a Wiener process describing t_{d} for 50% of V_{DD} crossing). Also, its variance σₜ_{_{w}}² is proportional to the mean value of t_{w}, being a Wiener process. As is understood in the art, the least significant bits (LSBs) of a counter digitizing a random pulsewidth t_{w} are highly sensitive to noise, and are also uniformly distributed, whereas the most significant bits (MSBs) are deterministically defined by μₜ_{_{w}}. Accordingly, t_{w} was converted to a uniform distribution by counting the RO 405 oscillations with the asynchronous counter 407 in the form of a modulo-counter according to an example embodiment, which retains only the last four LSBs of the overall count and hence greatly reduces area and power compared to a fully-fledged counter. The adoption of such modulo counter according to an example embodiment advantageously suppresses the static effect of local variations, as well as the impact of voltage and temperature variations that affect the mean value of t_{w}. This advantageously also eliminates the need for calibration, as the zero-mean noise results in a uniform distribution of LSBs and well-balanced 0/1 probability.

Formal security analysis of dynamic entropy generation (TRNG) source with a stochastic model is a common requirement for adoption in cryptographic applications, as per the existing standards (e.g., National Institute of Standards and Technology (NIST) 800-90B and Bundesamt für Sicherheit in der Informationstechnik (BSI) Application Notes and Interpretation of the Scheme (AIS)-31). Dynamic entropy generation according to an example embodiment can be analytically described as the process of generating a random pulsewidth from a capacitance discharge biased at very low current with Gaussian distribution N(μₜ_{_{w}}, σₜ_{_{w}}²) being an increment of a Wiener process. Dynamic entropy digitization converts this Gaussian distribution to a uniform one with maximum count of log₂(σₜ_{_{w}}/ƒᵣₒ) random output bits. This analytical model assumes that the overall jitter contribution (including the ring oscillator) and other non-idealities (an example is the mismatch in the flip-flops sampling the counter to capture the random asynchronous pulsewidth t_{w} at the falling edge of t_{w}) in the digitization loop are dominated by the accumulated jitter (σₜ_{_{w}}²) of the random pulsewidth t_{w}. Measurements presented below confirm the negligible impact of the non-idealities of the dynamic entropy digitization circuit, according to an example embodiment.

It is noted that in the above described RO-based TDC according to an example embodiment, the exponential dependence of the SRAM bitcells leakage discharging the bitline substantially slows down the bitline discharge process at lower temperatures, and hence leads to a substantially larger t_{w}. This unnecessarily increases the number of RO oscillations within t_{w}, and hence the energy/bit of the TRNG. To prevent such energy increase at low temperatures, the RO frequency ƒᵣₒ is adjusted according to an example embodiment using a current-starved tunable delay element 500 inside the ring oscillator 405 in FIG. 5(a). ƒᵣₒ is tuned by selecting one of the output voltages of the voltage divider 502 implemented with 20 diode-connected transistors in sub-threshold (e.g., 45-mV resolution at 0.9 V) in an example embodiment. A global digital feedback loop 504 periodically checks the RO count with a replica RO and a 12-bit counter, together indicated at numeral 506, which captures the count corresponding to μₜ_{_{w}} at the end of t_{w}, and adjusts ƒᵣₒ to maintain the average count at the intended target (i.e., nominal conditions indicated at numeral 508) within a threshold.

FIG. 5(b) describes the dynamic entropy generation and digitization processes according to an example embodiment, as determined by the bitline discharge (curve 510) after releasing its precharge (signal 512) with all bitcells on the wordline low (signal 514). The accumulated jitter is then converted into the random pulsewidth t_{w} according to the EN signal 515 using the high and low outputs form the skewed inverter pair (signals 516, 517, respectively), and then a random digital output (signal 518) by the RO-based TDC.

### Multibit Static Entropy (PUF) Digitization According to an Example Embodiment

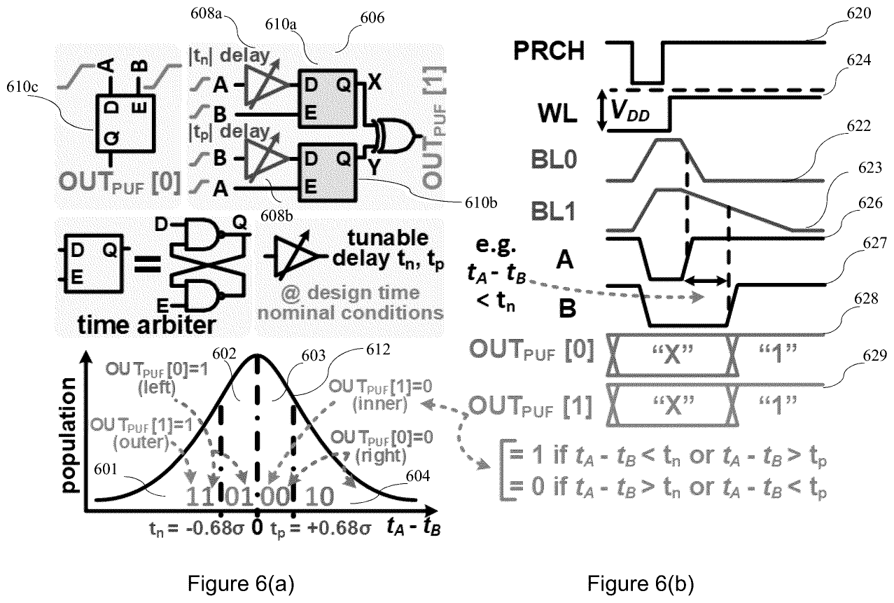

Multibit static entropy per PUF bitcell was obtained according to an example embodiment by digitizing the bitline discharge time difference (t_{A}−t_{B}) into one of four bins 601-604 in FIG. 6(a). This is achieved by converting (t_{A}−t_{B}) to digital via a delay line-based TDC 606 that uses delay and D-latches as time arbiters. In detail, the PUF LSB output PUF[0] is generated through direct comparison of (t_{A}−t_{B}) with a zero threshold using D-Latch 610c. PUF[0] results to 1 if (t_{A}−t_{B})<0, and 0 if (t_{A}−t_{B})≥0. The additional bit PUF[1] is the MSB of the 2-bit PUF output, and is generated by comparing (t_{A}−t_{B}) with non-zero delay thresholds using D-latches 610a,b that, together with the PUF LSB output PUF[0], divide the total population into four bins 601-604 with equivalent population. Such thresholds were evaluated and set to ±0.68σ at design time according to an example embodiment, as found by slicing the Gaussian distribution (graph 612) into four bins with 25% of the entire population (being σ the standard deviation of (t_{A}−t_{B}) at nominal conditions, as found from simulations).

More specifically, the TDC 606 output MSB PUF[1] is assigned to 0 if (t_{A}−t_{B}) falls inside the Gaussian lobe (i.e., the two central bins 602, 603), and to 1 otherwise. In the example embodiment, the delay lines 608a,b are implemented by current-starved inverter gates where the NMOS is driven by the wordline under-driven voltage to save on the number of inverter gates for the targeted nominal delay, and to track variations of supply voltage (noting that the under-driven voltage can be derived from the supply, as is understood in the art). The delay lines 608a,b are designed to generate the ±0.68σ thresholds at nominal conditions, and are used without any change at any voltage or temperature according to an example embodiment. The choice of such thresholds at design time is more than sufficient to achieve cryptographic-grade Shannon entropy according to an example embodiment, as described below, and hence does not require any calibration or testing effort. Interestingly, marginally stable or unstable bitcells lie at the boundary of the different bins, as those indeed jump across bins when leaving their stability region. Accordingly, routine PUF stabilization techniques (e.g., masking, temporal majority voting) automatically discard the bitcells at the boundary of the bins according to an example embodiment, without any extra calibration or testing across voltages and temperatures beyond conventional PUF stabilization.

It is noted that any time difference arbiter circuit may be used in different example embodiments.

For completeness, FIG. 6(b) pictorially describes the multibit static entropy generation and digitization, from bitline precharge (signal 620) to discharge (curves 622, 623) under moderately under-driven wordline (signal 624). The discharge time difference (signals 626, 627) within the bitcell pair is converted into 2-bit output using the delay line-based TDC outputs PUF[0] and PUF[1] (signals 628, 629). In principle, more than two bits per PUF bitcell can be derived from bitline discharge rate digitization according to various example embodiments, though at higher area due to the more complex TDC.

### TRNG Statistical Characterization and Resilience Against Attacks, According to an Example Embodiment

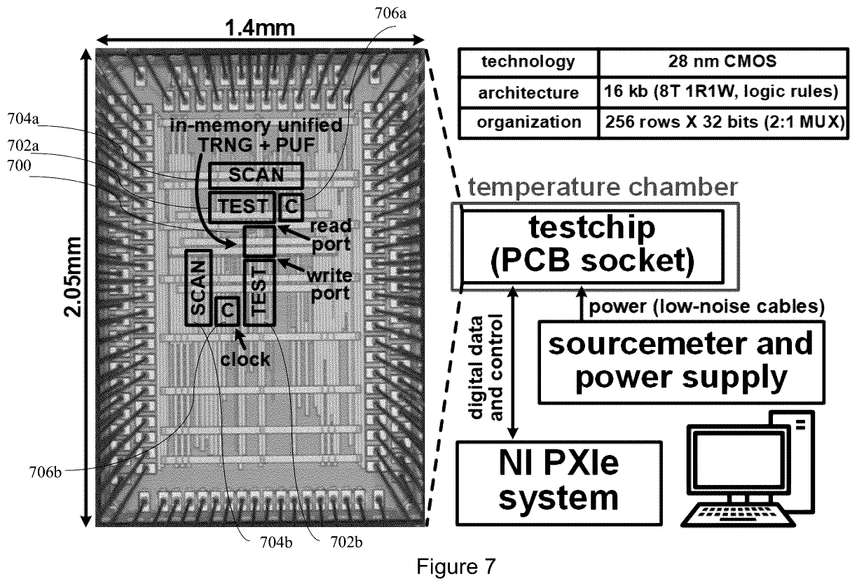

The in-memory unified entropy generation according to an example embodiment was implemented in a 16-kb dual-port (1R1 W) SRAM based on an 8T bitcell laid out with logic rules in 28 nm (see FIG. 7). The SRAM macro 700 with 256 rows and 32-bit I/O occupies an area of 15,400 μm², of which 6% accounts for the TRNG operation area overhead, and 6.7% for the PUF operation area overhead over the baseline SRAM. Five packaged dice according to example embodiments were characterized using a built-in self-test logic 702a,b, 704a,b for at-speed measurements with on-chip clock 706a,b.

### TRNG Statistical Characterization According to an Example Embodiment

The statistical quality of the output bitstream(s) under TRNG operation was evaluated through the min-entropy from NIST 800-90B tests, and the average p-value obtained from the NIST 800-22 tests. Every column generates 4 random bits per cycle, whose LSB bit is dropped according to an example embodiment, due to its highest sensitivity to mismatch in the counter flip-flops asynchronously capturing the falling edge of t_{w} inside the RO running at frequency ƒᵣₒ. The benefit of suppressing the LSB is confirmed by the degradation of its measured min-entropy down to 0.75, and maximum autocorrelation function (ACF) up to ±0.01 across operating conditions. Conventional Von Neumann correction was applied to only one of the three remaining bits to correct minor min-entropy degradation from 0.97 (worst-case operating conditions) to the >0.99 target across all conditions, at the expense of ˜75% throughput reduction leading to ˜2.25 random bits every column. Such minor entropy gap in only one of the output bits confirms the nearly-uniform distribution of the TRNG output bits under the non-idealities of the dynamic entropy digitization circuit, according to an example embodiment. Von Neumann extraction was implemented off-chip, and its area overhead of 6,000 F² is included in the area overhead of 36,000 F² per column (F=minimum feature size of the process), according to an example embodiment.

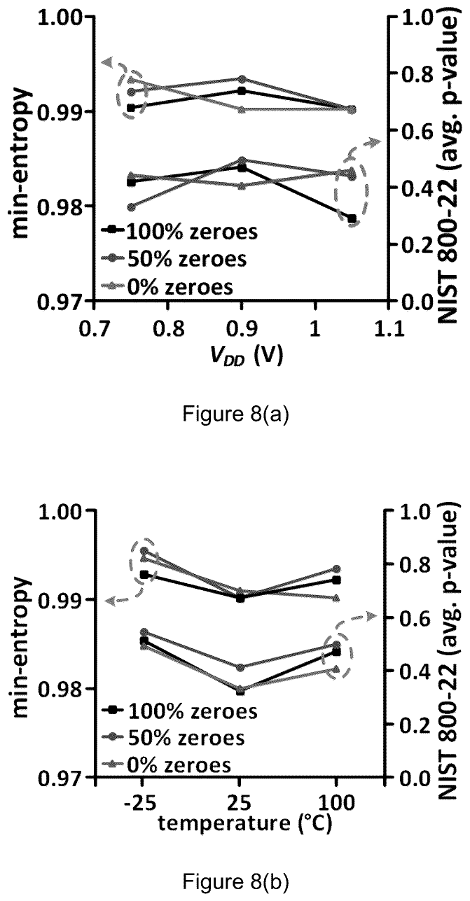

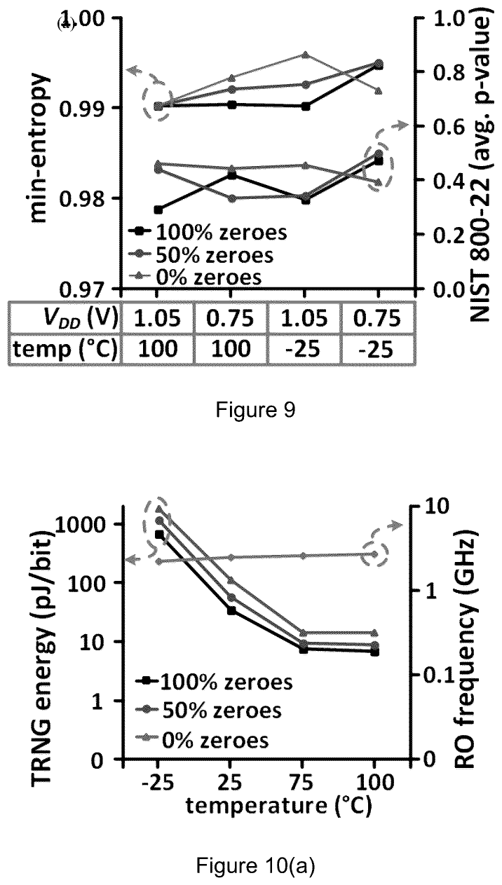

As shown by the measurements in FIG. 8(a), the min-entropy according to an example embodiment is confirmed to be better than the 0.99 target of NIST 800-90B tests across V_{DD} fluctuating by ±0.15 V around the nominal 0.9-V voltage, at the worst-case temperature of 100° C. (highest leakage, and hence minimum accumulated jitter). The TRNG output according to an example embodiment also passes all NIST 800-22 tests with an average p-value across all tests of 0.38, against an essential passing threshold of 0.01. FIG. 8(a) also shows the weak effect of the data pattern stored in bitcells within the same bitline, whose cumulative leakage tends to decrease when they store 1 from FIGS. 2 and 3 (due to the stacking effect in two-transistor bitcell read stack, when both transistors are “off” and conducting leakage). Indeed, from FIG. 8(a) the min-entropy target is achieved according to an example embodiment regardless of the data pattern from 0% to 100% zeroes along the bitline. From FIG. 8(b), the same results hold when temperature fluctuations in the −25-100° C. range at the nominal voltage (0.9 V) are added across the above data patterns, passing all NIST tests with min-entropy greater than 0.99 and average p-value of 0.42. When supply voltage variations in the 0.75-1.05 V are added to the above temperature variations and data pattern range, from FIG. 9 the TRNG output according to an example embodiment is confirmed to pass again all NIST 800-22 and NIST 800-90B tests with min-entropy greater than 0.993.

Overall, this means that the in-memory TRNG according to an example embodiment has an output with cryptographic-grade quality across all environmental conditions, regardless of the data pattern stored in the SRAM. This allows TRNG operation without any data flushing or any other data manipulation, enabling dynamic entropy generation at any time and without interfering with the SRAM content.

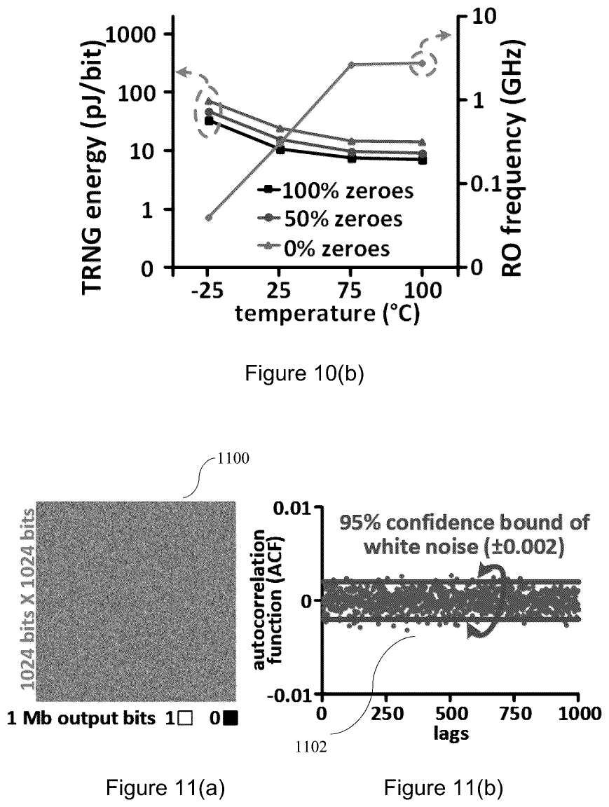

The energy under TRNG operation is dominated by the entropy digitization and in particular the RO energy, motivating its tuning as described above with reference to FIGS. 5(a)-(b). In detail, FIG. 10(a) shows that the TRNG energy without RO tuning suffers from an energy increase by up to two orders of magnitude at low temperatures in an example embodiment, whereas RO tuning according to a preferred embodiment mitigates such energy increase by more than an order of magnitude as shown in FIG. 10(b). The residual energy increase at low temperatures (i.e., slower bitline discharge) in FIG. 10(b) can be attributed to the inherently higher short-circuit energy of skewed inverters.

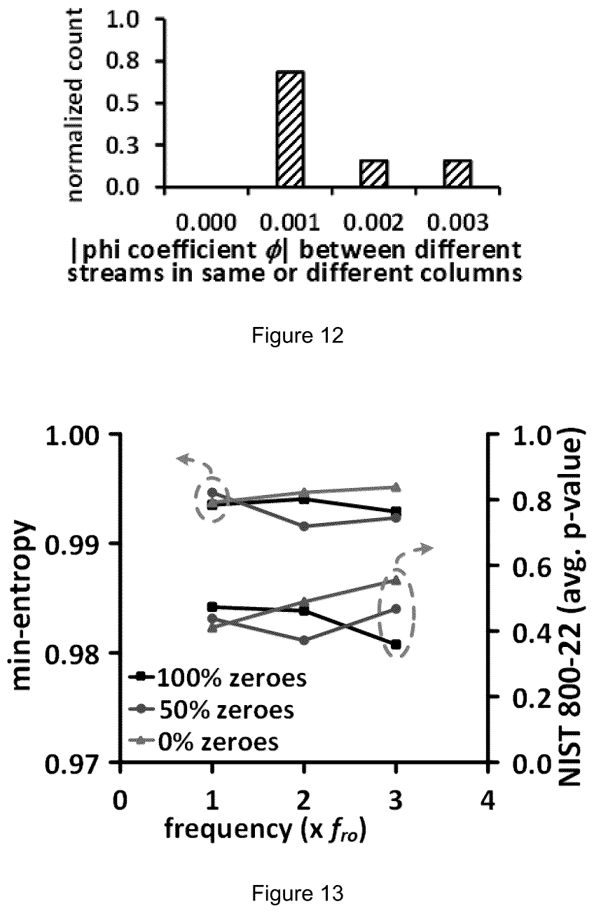

FIGS. 11-12 shows the randomness evaluation of the TRNG output according to an example embodiment measured under worst-case condition (0.75 V and 100° C.), based on 1-Mb bitstream. Referring to individual bitstreams, FIGS. 11(a)-(b) shows the speckle diagram 1100 and the autocorrelation function (graph 1102) over 1,000 lags. The absence of any obvious pattern in the former and the autocorrelation function (ACF) floor below the confidence bound of the Gaussian white noise distribution confirm the absence of temporal correlation. Regarding the possible inter-dependence of multiple bitstreams, FIG. 12 shows the histogram of the phi-coefficient between different bitstreams from the same and from different columns. The resulting measured phi-coefficient distribution has a mean of μ=0.001 and standard deviation of σ=0.0009, both of which indicate the near-zero correlation across bitstreams as independent sources of randomness. Table I (II) shows the NIST 800-22 (NIST 800-90B) test suite results under default settings for a total of 50 Mb measured data, based on 1-Mb bitstreams at the worst-case condition (0.75 V and 100° C.).

TABLE I

| Test | p-value | Pass? |
|---|---|---|
| Frequency | 0.154 | Yes |
| Block Frequency | 0.680 | Yes |
| Runs | 0.610 | Yes |
| Longest Runs | 0.285 | Yes |
| Rank | 0.958 | Yes |
| FFT | 0.611 | Yes |
| Non-Overlapping Template | 0.990 | Yes |
| Overlapping Template | 0.356 | Yes |
| Universal | 0.999 | Yes |
| Linear Complexity | 0.805 | Yes |
| Serial | 0.272 | Yes |
| Approximate Entropy | 0.330 | Yes |
| Cumulative Sums | 0.234 | Yes |
| Random Excursions | 0.056 | Yes |
| Random Excursions Variant | 0.038 | Yes |

TABLE II

| Test | Result (score, degree of freedom) |
|---|---|
| IID Permutation | PASS (N/A, N/A) |
| Chi-square Independence | PASS (2,082.65, 2,046) |
| Chi-square Goodness of fit | PASS (7.27, 9) |
| LRS Test | PASS (N/A, N/A) |
| Min. Entropy | 0.993 |
| Restart Test | PASS (N/A, N/A) |

### TRNG Resilience Against Attacks, According to an Example Embodiment

Power supply frequency injection attacks are commonly adopted against TRNGs based on ring oscillators as direct source of entropy. The in-memory TRNG according to an example embodiment is expected to be highly resilient against such attacks, considering that its main randomness source is the accumulated jitter (σₜ_{_{w}}²) of random pulsewidth t_{w} rather than from accumulated or cycle-to-cycle jitter (σ_{fro}²) of ring oscillator (RO) frequency. The measured resilience against power supply frequency injection attacks is shown in FIG. 13 according to an example embodiment under 0.3 Vₚ₋ₚ injection superimposed to the 0.9-V supply voltage, at the worst-case temperature of −25° C. and at various multiple values of the measured RO oscillator frequency of 84.5 MHz. The nearly-constant min-entropy greater than 0.99 assures full pass of NIST tests under such attacks and across highly-skewed data patterns in SRAM, and also confirms the insignificance of the impact of the RO frequency jitter (σ_{fro}²) on the TRNG output, according to an example embodiment.

Assuming a highly-pessimistic threat model where the attacker can unrestrictedly control the entire address space (This is a quite unlikely scenario, as memory protection is a widespread feature that is available even at the lowest end of system complexity (e.g., ARM Cortex-MO microcontroller in configurations with few tens of kgates), the in-memory TRNG according to an example embodiment delivers a min-entropy greater than 0.99 even under extreme stored data bias with all zeroes or all ones (see FIGS. 8-9). Conversely, the cryptographic-grade random output statistics inherently prevents SRAM data extraction from the TRNG output bitstream, according to an example embodiment.

### PUF Statistical Characterization and Resilience Against Attacks, According to an Example Embodiment

### PUF Statistical Characterization According to an Example Embodiment

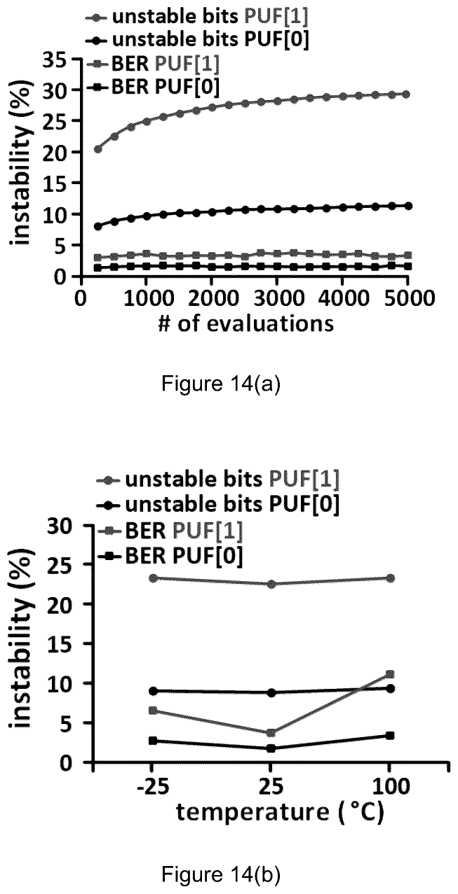

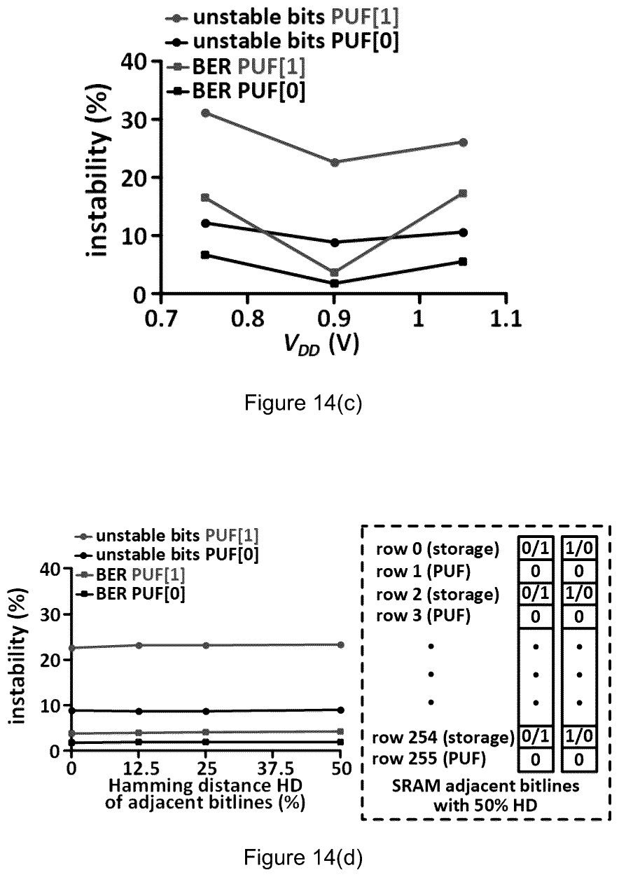

The raw stability of the 2-bit PUF output (PUF[1], PUF[0]) generated at every SRAM column according to an example embodiment is reported in FIGS. 14(a)-(d), based on the golden key evaluated for each die at nominal conditions (0.9 V and 25° C.). Qualitatively, the LSB output PUF[0] stability at nominal conditions according to an example embodiment is expected to be similar to conventional SRAM PUFs, whereas MSB output PUF[1] stability is ˜2× lower due to entropy quantization around two decision boundaries versus one decision boundary (i.e., four bins versus two bins), as shown in FIG. 3 and FIG. 6(a). More quantitatively, FIG. 14(a) shows that the BER at nominal conditions for the LSB (MSB) output PUF[0] (PUF[1]) is 1.8% (3.78%) and its unstable bits are 11.5% (30%) according to an example embodiment, in line with existing 1-bit SRAM PUFs.

The effect of temperature on stability in FIG. 14(b) is minor, as quantified by a BER sensitivity of 0.02%/° C. (0.098%/° C.) for PUF[0] (PUF[1]), and 0.007%/° C. (0.016%/° C.) for the unstable bits across the considered −25-100° C. range. Regarding voltage variations, FIG. 14(c) shows that their effect is more pronounced and leads to a BER sensitivity of 0.032%/mV (0.09%/mV) for PUF[0] (PUF[1]), and 0.022%/mV (0.057%/mV) for the unstable bits across the considered supply voltage 0.75-1.05 V range.

As described above with reference to FIG. 3, PUF operation according to an example embodiment has the same data is stored in adjacent bitcells belonging to the selected rows associated with the PUF. No data pattern restriction applies to unselected rows, allowing conventional storage everywhere else. The data pattern in rows used for conventional read/write has an insignificant impact on the PUF output according to an example embodiment, as the data-dependent cumulative bitline leakage is a very small fraction of the read current used by the PUF in all practical cases. This is shown in FIG. 14(d), where stability is nearly constant regardless of the Hamming distance HD between the two adjacent bitlines within the column generating the PUF output, with HD widely ranging from 0% to 50% (i.e., from identical data to random). 50% HD in FIG. 14(d) corresponds to 50% of SRAM rows per bank (128 in an example embodiment) being allocated to conventional data storage, and storing the worst-case pattern with all pairs storing complementary bits. Hence, the resulting 0.83% instability degradation of PUF[1] according to an example embodiment represents an upper bound of unstable bit degradation for any arbitrary data pattern in favorable cases where half of an SRAM bank is retained for conventional read/write. This minor degradation is explained by the conventionally high ratio (e.g., >10³) between the SRAM bitcell read current and the data-dependent bitline leakage. Accordingly, the in-memory PUF according to an example embodiment allows coexistence of the fixed data (e.g., 0 in FIG. 3) for PUF operation in selected rows and stored bits in others for conventional access. In turn, this enables flexible mixture of words within the same bank and column for both tasks, without the need of any additional hardware segregation method between them, according to an example embodiment.

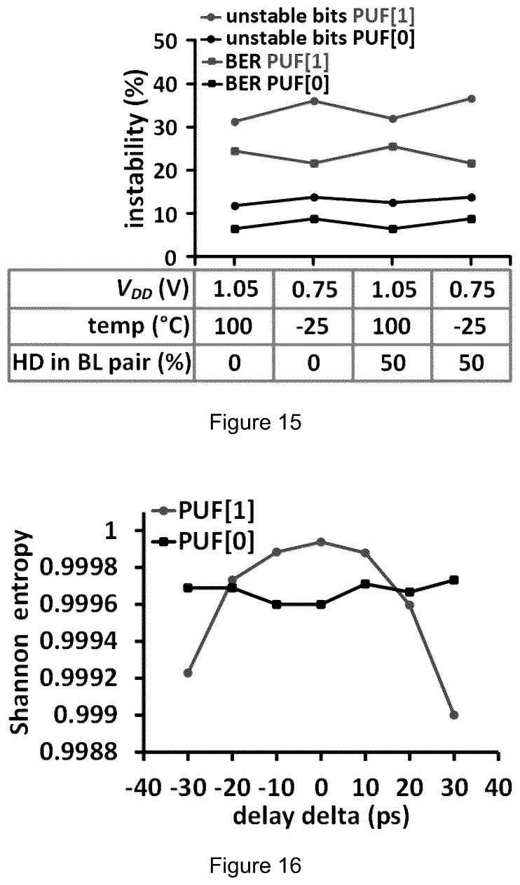

The joint effect of worst-case voltages, temperatures and Hamming distance of adjacent columns comparing with golden key at nominal conditions (0.9 V, 25° C., 0 Hamming distance) is depicted in FIG. 15. From this figure, the worst-case BER for PUF[0] (PUF[1]) is 8.8% (25.4%) and unstable bits are 13.8% (36.5%) according to an example embodiment, which is again well in line with existing 1-bit SRAM PUFs.

The robustness of multibit PUF output according to an example embodiment against variations in the delay line within the TDC is analyzed in the following. As expected, the Shannon entropy of PUF[0] is independent of delay line variations, whereas the Shannon entropy of PUF[1] depends on delay variations due to the binning approach adopted for multibit static entropy digitization. Deviations in the delay lines due to random local mismatch from the ±0.68σ design target according to an example embodiment tend to decrease the Shannon entropy of PUF[1] output, due to the asymmetric population density in the different bins. FIG. 16 shows the measured impact of Shannon entropy degradation in PUF[0] and PUF[1] at nominal conditions (0.9 V and 25° C.) according to an example embodiment, where intentional delay is injected in both delay lines simultaneously in the same direction. Intentional delay tuning is achieved by biasing the current-starved inverters gates of the delay lines via an off-chip analog voltage with simulated sensitivity of 10 ps per 5 mV. As expected, the Shannon entropy of PUF[0] according to an example embodiment is independent of intentional delay tuning, and hence global delay variations (see FIG. 16). The Shannon entropy of PUF[1] according to an example embodiment is always greater than 0.999 even at ±30 ps simultaneous delay injection in both delay lines, as shown in FIG. 16. This translates to ˜99.9% yield with Shannon entropy greater than 0.99 (or ˜95% yield with Shannon entropy greater than 0.999), with local variations determining a delay with standard deviation of σ=22.5 ps in each delay line (from simulations). Different yield and Shannon entropy target combinations can be achieved by appropriately sizing the transistors within current starving inverter gates of delay lines, according to example embodiments.

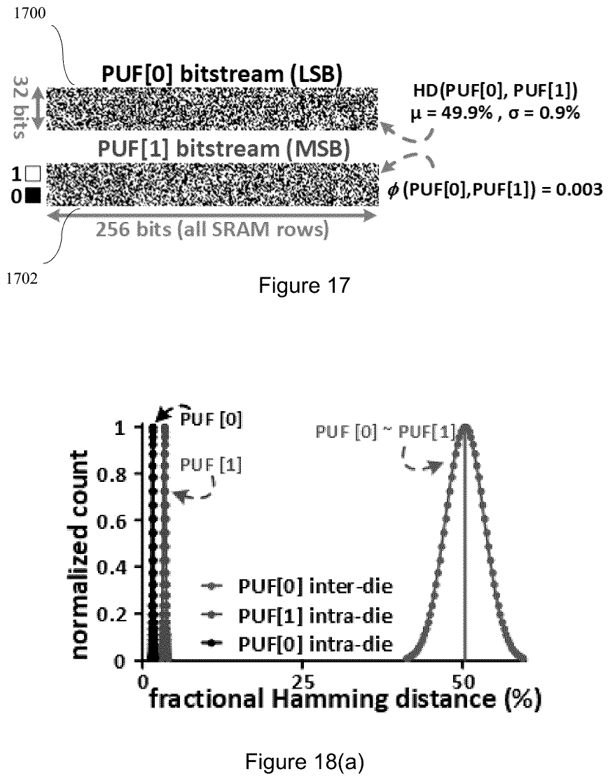

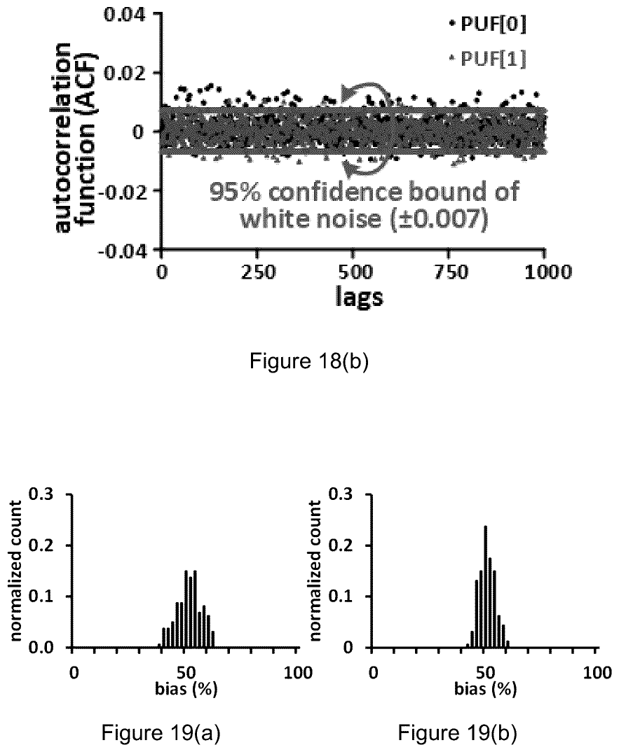

The randomness of the 2-bit PUF output according to an example embodiment is shown in FIGS. 17-18. The speckle diagrams 1700, 1702 in FIG. 17 qualitatively shows the absence of any spatial gradient or correlation. The independence of PUF[0] and PUF[1] is confirmed by their measured Hamming distance with near-ideal mean of μ=49.9% and standard deviation of σ=0.9%, as well as a near-zero phi-coefficient of 0.003 in FIG. 17. Measured intra-die Hamming distance (i.e., repeatability according to example embodiments) for PUF[0] has mean of μ=1.6% and standard deviation of 6=0.1%, and for PUF[1] has mean of μ=3.4% and standard deviation of 6=0.2% as shown in FIG. 18(a). From FIG. 18(a), the measured distribution of the PUF inter-die Hamming distance (i.e., uniqueness) has a near-ideal mean value mean of μ=50.3% and standard deviation of σ=3.04% for both PUF[0] and PUF[1]. The inter-die to intra-die Hamming distance ratio (i.e., PUF identifiability) is greater than 32× for PUF[0], and 14× for PUF[1]. The measured Shannon entropy is always greater than 0.9997 and PUF output passes all applicable NIST 800-22 tests. The randomness of the PUF output is also confirmed by the small confidence bound in the autocorrelation function (ACF) within ±0.007 for both PUF[0] and PUF[1], from FIG. 18(b). Quantitatively, the ACF in FIG. 18(b) confirms insignificant correlation among bits within the same column (i.e., 1 column=256 rows or lags in an example embodiment). This confirms the negligible impact of any column non-idealities (e.g., correlation in C_{BL} or other column-wise circuitry). As further evidence, FIGS. 19(a)-(b) show the measured distribution for PUF[0] and PUF[1] bias along the SRAM columns across dice, according to an example embodiment. The mean of μ=50.3% (49.8%) for the bias of PUF[0] (PUF[1]) and its narrow distribution with standard deviation of 6=5.5% further confirms the negligible impact of correlated variations within the same column.

PUF Resilience Against Attacks

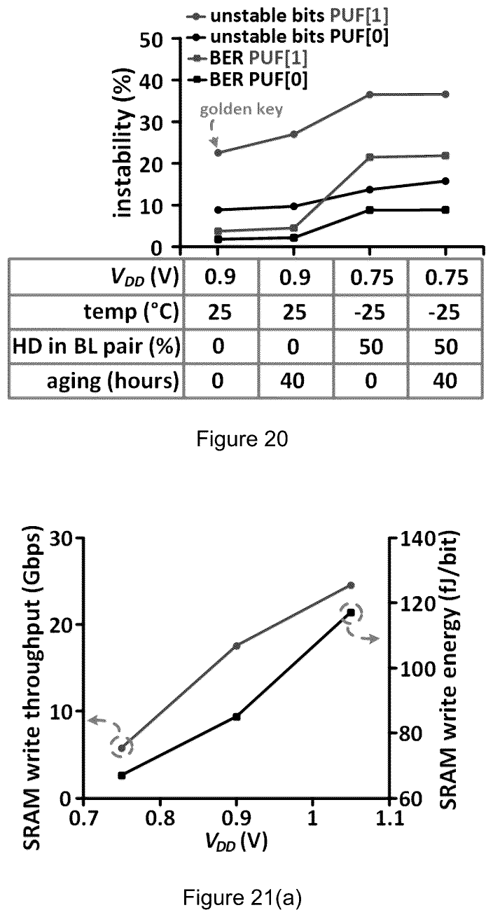

The reliability of the PUF stability is potentially impacted by long-term transistor degradation effects such as bias temperature stability and hot carrier injection. To study the effect of accelerated aging as a possible attack vector, the above highly-pessimistic threat model where the adversary can unrestrictedly store differential data (i.e., 0 and 1, or vice versa) in pairs of adjacent SRAM bitcells is assumed. Malicious accelerated aging aims to modify the strength of the NMOS two-transistor stack involved in bitcell read, given the bitline precharge at V_{DD} and the circuit principle that the PUF is based on (see FIG. 3, right-hand side), according to an example embodiment. Between the two NMOS transistors, the dominant impact of aging is associated with the pull-down transistor due to data-dependent biasing conditions being driven by pairs of adjacent SRAM bitcells compared to the access transistor. Also, this is due to the adopted under-driven wordline scheme according to an example embodiment, which has the side benefit of exponentially reducing electrical stress on the access transistor. At the same time, the sensitivity of the PUF output bit on the pull-down transistor is also much lower than the access transistor due to wordline under-driving. Indeed, the sensitivity of the bitline discharge time (i.e., PUF output) on the pull-down transistor according to an example embodiment was found to be 5× lower than the access transistor, from 10,000-run Monte Carlo simulations at the typical corner, 0.9 V, the adopted 20% wordline under-driving, and 25° C. Based on these observations, the effect of accelerated aging on the PUF output according to an example embodiment is expected to be minor even when the data stored is maliciously skewed to affect the PUF output during the lifespan of the system. This was confirmed by experiments, storing differential data in adjacent SRAM bitcell pairs for cumulative 40 hours at 1.26 V (i.e., 20% higher than maximum allowed supply voltage) and 125° C. without clock (i.e., no activity) for maximum DC stress conditions, corresponding to several-year usage. The resulting effect on stability in FIG. 20 confirms that aging has a minor effect according to an example embodiment, as quantified by a maximum 4.4% (0.77%) increase in unstable bits (BER) at nominal conditions (0.9 V and 25° C.) and by a maximum 2% (0.37%) increase in unstable bits (BER) at worst-case conditions (see FIG. 15).

Based on the same highly-pessimistic threat model of unrestricted control of the entire memory space, the specific data pattern stored in bitcells not directly involved in PUF output generation might be manipulated to influence the PUF output or gain an insight into the PUF bits. The experimental results in FIGS. 14, 15 and 20 confirm that such attacks are inherently counteracted by the insignificant dependence of stability on the SRAM content, according to an example embodiment. Conversely, the cryptographic-grade randomness of the PUF output according to an example embodiment prohibits any meaningful inference of the SRAM content.

### Throughput and Energy According to an Example Embodiment

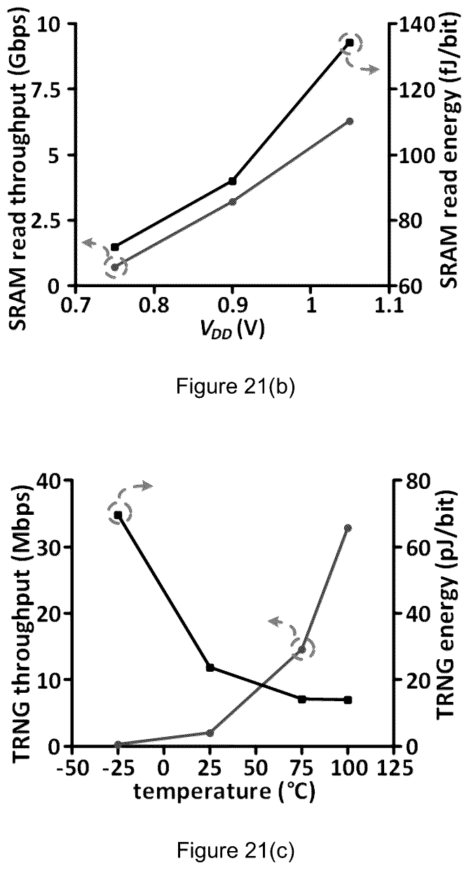

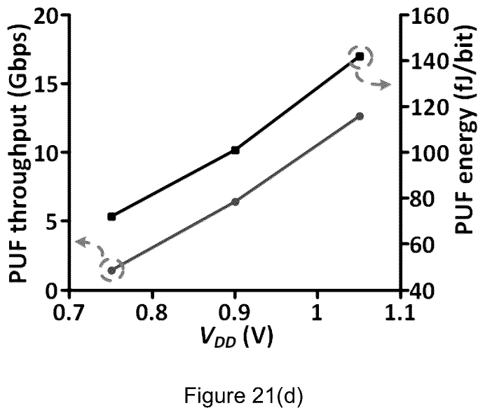

The throughput and energy in conventional SRAM write/read accesses is shown in FIGS. 21(a)-(b) versus V_{DD}, from which the overall SRAM speed is limited by the 6.3-Gbps throughput allowed by read accesses, under the adopted 20% wordline under-driving and room temperature (25° C.). The minimum energy/bit in write (read) mode is 68 fJ/bit (71.9 fJ/bit) at 0.75 V.

In TRNG operation according to an example embodiment, the maximum throughput is 1.97 Mbps from FIG. 21(c) at 0.75 V, 25° C. and worst-case data pattern (0% zeroes stored along the bitline). The minimum energy is 15.13 pJ/bit at 0.75 V, 25° C. and under the realistic case where 50% zeroes are stored along the bitline, which increases to 23.7 pJ/bit in the extreme case of 0% zeroes. To gain an insight into the temperature dependence of the TRNG energy according to an example embodiment, FIG. 21(c) shows that the energy/bit decreases at higher temperatures from 45.3 pJ/bit at −25° C. to 8.8 pJ/bit at 100° C. with 50% zeroes stored along the bitline with tuning loop (see FIG. 5 and FIG. 10). Instead, the TRNG throughput dependence on V_{DD} is minor (i.e., within 10%) across 0.75-1.05 V according to an example embodiment, and hence omitted in FIG. 21(c). Regarding PUF operation according to an example embodiment, the maximum throughput of 12.6 Gbps is achieved at 1.05 V, whereas the minimum energy is 72 fJ/bit at 0.75 V at 25° C.

The area overhead of the TRNG according to an example embodiment is 16,000-F 2 per random bitstream corresponding to 12.54 μm², and is fully integrated in the SRAM bank periphery thanks to its all-digital nature. The extra area for TRNG operation according to an example embodiment was found to be lower than existing non-unified TRNGs by 8.8-18.8×.

The architecture according to an example embodiment is the first multibit/bitcell SRAM PUF, according to the inventors knowledge. PUF operation according to an example embodiment achieves an area/bit of 1,125 F², which is lower than existing SRAM PUFs by 2.1-4.7×. The maximum throughput of 12.6 Gbps was found to be better than existing PUFs by 1.46-1,261,600×. Compared to existing SRAM PUFs, the energy/bit according to an example embodiment was found to be 5× lower than existing 1-bit SRAM PUF which can reuse existing bitcells.

As described above, an example embodiment of the present invention provides a unified SRAM with both dynamic (TRNG) and static (PUF) entropy generation has been introduced to enable complete secure key generation directly in memory. In addition to the inclusion of a TRNG in memory, the PUF is multibit for area efficiency improvement, according to an example embodiment.

Both the TRNG and the PUF according to an example embodiment share the same operating principle and enable extensive circuit reuse across functions, keeping the extra area for entropy generation to 12.7% of a traditional SRAM. As the architecture according to an example embodiment applies to the bank level, the area overhead can be further reduced by unifying key generation with a sub-set of the available banks (e.g., 0.8% when applied to a single bank in a 32-kB array), in example embodiment. The reuse of the original array with all-digital augmentation of the periphery according to an example embodiment preserves fully-automated memory compiler-based design, full reuse of existing bitcells (e.g., foundry-provided) and design portability, while reducing the system integration effort and eliminating typical physical attack points. The unified architecture according to an example embodiment delivers cryptographic-grade randomness across all operating points under both TRNG and PUF operation. The insensitivity of the entropy against the data pattern stored allows flexible usage of portions of each bank for read/write, TRNG and PUF with no additional segregation methods or bank flushing for uninterrupted SRAM usage.

In view of the pervasive nature of SRAMs in today's systems on chip, the in-memory unified TRNG and multibit PUF according to an example embodiment makes entropy generation ubiquitous in next-generation systems down to ultra-low cost.

### Extension to Other Embedded Memories According to Example Embodiments

The present invention can be applied to other forms of embedded memory. For example, in addition to SRAM described in the example embodiment above, the present invention can also be applied to DRAM, ROM, or flash memory. More specifically, the cumulative random noise on capacitance (i.e., one or more bitlines) discharge under low current (e.g., leakage current) to generate and digitize the dynamic (TRNG) entropy can be directly applied in DRAM, ROM or flash memory due to the two-dimensional array organization connecting multiple memory bitcell on bitlines (i.e., capacitance) and similar architecture of row decoder enabling the biasing of all wordlines to low. Similarly, ROM or flash memory works on sensing the discharge rate of precharged bitline capacitance based on the bitcell programmed (e.g., metal via connection for ROM with mask) or stored value (e.g., electron storage in the floating gate for flash). Static entropy (PUF) can be generated by comparing and digitizing the bitline discharge rate of two adjacent precharged bitlines with underdriven wordline voltage set by row decoder to emphasize the impact of random local (i.e., intra-die) variations.

In one embodiment, an embedded memory structure is provided comprising an array of bitcells interconnected by a plurality of bitlines and a plurality of wordlines, each bitcell comprising a transistor connected to one of the wordlines and one of the bitlines; and a true random number generator, TRNG, circuit peripheral to the array of bitcells, with an input of the TRNG circuit coupled to one or more of the bitlines; wherein the TRNG circuit is configured to
set transistors connected to the one or more of the bitlines to an off state,
to determine a time interval between different crossing thresholds in a voltage discharge in the one or more bitlines, and
to digitize the time interval into bits of an TRNG output.

The TRNG circuit may comprise a column peripheral circuit for determining the time interval between the different crossing thresholds in the voltage discharge in the one or more bitlines and for digitizing the time interval into the bits of the TRNG output. The column peripheral circuit may comprise a skewed inverter pair and a time-to-digital converter.

The column peripheral circuit may comprise a voltage tuning loop to adjust a time-to-digital converter for digitizing the time interval for a substantially constant energy-per-bit conversion of the time interval into the bits of the TRNG output.

The TRNG circuit may comprise a row decoder connected to the array of bitcells and to a global timing signal control block, and configured to set all wordlines to low level for setting the transistors connected to the bitlines to the off state.

The TRNG circuit may be connected to the one or more bitlines via one or more column multiplexers.

The TRNG circuit may be connected to the one or more bitlines bypassing one or more column multiplexers.

In one embodiment, an embedded memory structure is provided, comprising an array of bitcells interconnected by a plurality of bitlines and a plurality of wordlines, each bitcell comprising a transistor connected to one of the wordlines and one of the bitlines; and a physically unclonable function, PUF, circuit peripheral to the array of bitcells, with an input of the PUF circuit coupled to one or more pairs of bitlines; wherein the PUF circuit is configured to
set a pair of transistors connected to respective ones of the pair of bitlines and to the same wordline to an underdriven state,
to determine respective times, t_{A}, t_{B}, of the transistors of the pair crossing a threshold in a voltage discharge in the pair of bitlines, and
to digitize a difference between t_{A} and t_{B} into an n-bit PUF output, wherein n is an integer ≥2.

The input of the PUF circuit may be coupled to the pair of bitlines directly, i.e., bypassing a column multiplexer.

The PUF circuit may comprise a column peripheral circuit for determining the respective times, t_{A}, t_{B}, and for digitizing the difference between t_{A} and t_{B} into the n-bit PUF output. The column peripheral circuit may comprise a time difference arbiter circuit.

The PUF circuit may comprises a row decoder connected to the array of bitcells and to a global timing signal control block, and configured to set the pair of transistors connected to the pair of bitlines and to the same wordline to the underdriven state.

In one embodiment, an embedded memory structure is provided, comprising an array of bitcells interconnected by a plurality of bitlines and a plurality of wordlines, each bitcell comprising a transistor connected to one of the wordlines and one of the bitlines; and a true random number generator, TRNG, circuit peripheral to the array of bitcells, with an input of the TRNG circuit coupled to one or more of the bitlines; wherein the TRNG circuit is configured to
set transistors connected to a one of said one or more of the bitlines to an off state,
to determine a time interval between different crossing thresholds in a voltage discharge in the one or more bitlines, and
to digitize the time interval into bits of an TRNG output;
   a physically unclonable function, PUF, circuit peripheral to the array of bitcells, with an input of the PUF circuit coupled to one or more pairs of bitlines; wherein the PUF circuit is configured to
set a pair of transistors connected to respective ones of the pair of bitlines and to the same wordline to an underdriven state,
to determine respective times, t_{A}, t_{B}, of the transistors of the pair crossing a threshold in a voltage discharge in the pair of bitlines, and
to digitize a difference between t_{A} and t_{B} into an n-bit PUF output, wherein n is an integer ≥2.

The TRNG circuit may comprise a first column peripheral circuit for determining the time interval between the different crossing thresholds in the voltage discharge in the one or more bitlines and for digitizing the time interval into the bits of the TRNG output. The first column peripheral circuit may comprise a skewed inverter pair and a time-to-digital converter.

The first column peripheral may comprise a voltage tuning loop to adjust a time-to-digital converter for digitizing the time interval for a substantially constant energy-per-bit conversion of the time interval into the bits of the TRNG output.

The TRNG circuit may comprise a row decoder connected to the array of bitcells and to a global timing signal control block, and configured to set all wordlines to low level for setting the transistors connected to the bitlines to the off state.

The TRNG circuit may be connected to the one or more bitlines via one or more column multiplexers.

The TRNG circuit may be connected to the one or more bitlines bypassing one or more column multiplexers.

The input of the PUF circuit may be coupled to a pair of bitlines directly, i.e., bypassing a column multiplexor.

The PUF circuit may comprise a second column peripheral circuit for determining the respective times, t_{A}, t_{B}, and for digitizing the difference between t_{A} and t_{B} into the n-bit PUF output. The second column peripheral circuit may comprise a time difference arbiter circuit.

The PUF circuit may comprise a row decoder connected to the array of bitcells and to a global timing signal control block, and configured to set the pair of transistors connected to the pair of bitlines and to the same wordline to the underdriven state.

The embedded memory may comprise a SRAM, DRAM, ROM, or Flash memory.

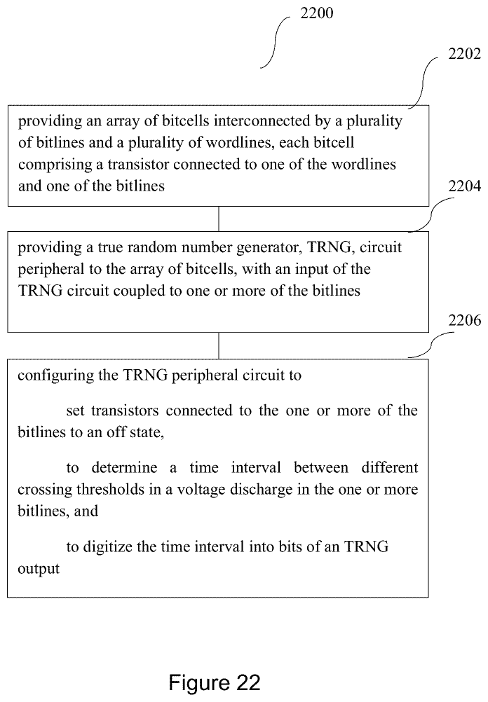

FIG. 22 shows a flowchart 2200 illustrating a method of fabricating an embedded memory structure, according to an example embodiment. At step 2202, an array of bitcells interconnected by a plurality of bitlines and a plurality of wordlines is provided, each bitcell comprising a transistor connected to one of the wordlines and one of the bitlines. At step 2204, a true random number generator, TRNG, circuit peripheral to the array of bitcells is provided, with an input of the TRNG circuit coupled to one or more of the bitlines. At step 2206, the TRNG peripheral circuit is configured to
set transistors connected to the one or more of the bitlines to an off state,
to determine a time interval between different crossing thresholds in a voltage discharge in the one or more bitlines, and
to digitize the time interval into bits of an TRNG output.

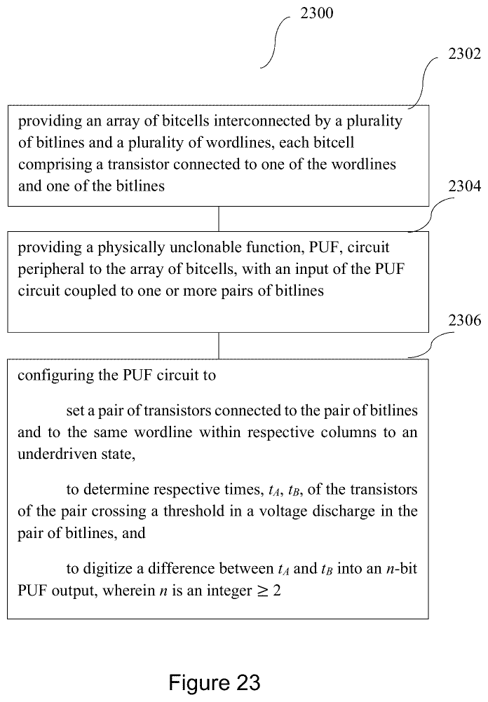

FIG. 23 shows a flowchart 2300 illustrating a method of fabricating an embedded memory structure, according to an example embodiment. At step 2302, an array of bitcells interconnected by a plurality of bitlines and a plurality of wordlines is provided, each bitcell comprising a transistor connected to one of the wordlines and one of the bitlines. At step 2304, a physically unclonable function, PUF, circuit peripheral to the array of bitcells is provided, with an input of the PUF circuit coupled to one or more pairs of bitlines. At step 2306, the PUF circuit is configured to
set a pair of transistors connected to the pair of bitlines and to the same wordline within respective columns to an underdriven state,
to determine respective times, t_{A}, t_{B}, of the transistors of the pair crossing a threshold in a voltage discharge in the pair of bitlines, and
to digitize a difference between t_{A} and t_{B} into an n-bit PUF output, wherein n is an integer ≥2.

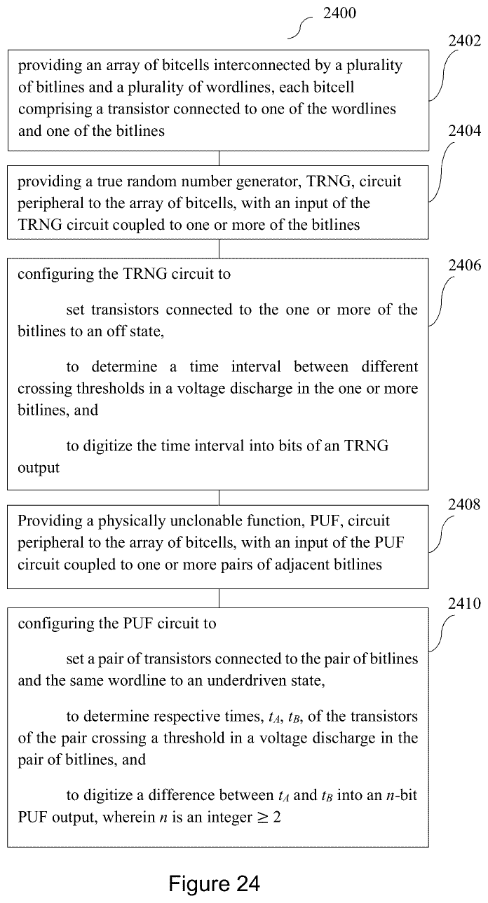

FIG. 24 shows a flowchart 2400 illustrating a method of fabricating an embedded memory structure, according to an example embodiment. At step 2402, an array of bitcells interconnected by a plurality of bitlines and a plurality of wordlines is provided, each bitcell comprising a transistor connected to one of the wordlines and one of the bitlines. At step 2404, a true random number generator, TRNG, circuit peripheral to the array of bitcells is provided, with an input of the TRNG circuit coupled to one or more of the bitlines. At step 2406, the TRNG circuit is configured to
set transistors connected to the one or more of the bitlines to an off state,
to determine a time interval between different crossing thresholds in a voltage discharge in the one or more bitlines, and
to digitize the time interval into bits of an TRNG output.

At step 2408, a physically unclonable function, PUF, circuit peripheral to the array of bitcells is provided, with an input of the PUF circuit coupled to one or more pairs of adjacent bitlines. At step 2410, the PUF circuit is configured to
set a pair of transistors connected to the pair of bitlines and the same wordline to an underdriven state,
to determine respective times, t_{A}, t_{B}, of the transistors of the pair crossing a threshold in a voltage discharge in the pair of bitlines, and
to digitize a difference between t_{A} and t_{B} into an n-bit PUF output, wherein n is an integer ≥2.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. An embedded memory structure comprising:
an array of bitcells interconnected by a plurality of bitlines and a plurality of wordlines, each bitcell comprising a transistor connected to one of the wordlines and one of the bitlines; and
a true random number generator, TRNG, circuit peripheral to the array of bitcells, with an input of the TRNG circuit coupled to one or more of the bitlines;
wherein the TRNG circuit is configured to:
set transistors connected to the one or more of the bitlines to an off state,
determine a time interval between different crossing thresholds in a voltage discharge in the one or more bitlines, and
digitize the time interval into bits of an TRNG output.

2. The SRAM structure of claim 1, wherein the TRNG circuit comprises a column peripheral circuit for determining the time interval between the different crossing thresholds in the voltage discharge in the one or more bitlines and for digitizing the time interval into the bits of the TRNG output, and optionally wherein the column peripheral circuit comprises a skewed inverter pair and a time-to-digital converter.

3. (canceled)

4. The SRAM structure of claim 2, wherein the column peripheral circuit comprises a voltage tuning loop to adjust a time-to-digital converter for digitizing the time interval for a substantially constant energy-per-bit conversion of the time interval into the bits of the TRNG output.

5. The SRAM structure of claim 1, wherein the TRNG circuit comprises a row decoder connected to the array of bitcells and to a global timing signal control block, and configured to set all wordlines to low level for setting the transistors connected to the bitlines to the off state.

6. The SRAM structure of claim 1, wherein the TRNG circuit is connected to the one or more bitlines via one or more column multiplexers.

7. The SRAM structure of claim 1, wherein the TRNG circuit is connected to the one or more bitlines bypassing one or more column multiplexers.

8. An embedded memory structure comprising:
an array of bitcells interconnected by a plurality of bitlines and a plurality of wordlines, each bitcell comprising a transistor connected to one of the wordlines and one of the bitlines; and
a physically unclonable function, PUF, circuit peripheral to the array of bitcells, with an input of the PUF circuit coupled to one or more pairs of bitlines;
wherein the PUF circuit is configured to:
set a pair of transistors connected to respective ones of the pair of bitlines and to the same wordline to an underdriven state,
determine respective times, t_{A}, t_{B}, of the transistors of the pair crossing a threshold in a voltage discharge in the pair of bitlines, and
digitize a difference between t_{A} and t_{B} into an n-bit PUF output, wherein n is an integer ≥2.

9. The SRAM structure of claim 8, wherein the input of the PUF circuit is coupled to the pair of bitlines directly, i.e., bypassing a column multiplexer.

10. The SRAM structure of claim 8, wherein the PUF circuit comprises a column peripheral circuit for determining the respective times, t_{A}, t_{B}, and for digitizing the difference between t_{A} and t_{B} into the n-bit PUF output.

11. The SRAM structure of claim 8, wherein the column peripheral circuit comprises a time difference arbiter circuit.

12. The SRAM structure of claim 8, wherein the PUF circuit comprises a row decoder connected to the array of bitcells and to a global timing signal control block, and configured to set the pair of transistors connected to the pair of bitlines and to the same wordline to the underdriven state.

13. An embedded memory structure comprising:
an array of bitcells interconnected by a plurality of bitlines and a plurality of wordlines, each bitcell comprising a transistor connected to one of the wordlines and one of the bitlines; and
a true random number generator, TRNG, circuit peripheral to the array of bitcells, with an input of the TRNG circuit coupled to one or more of the bitlines;
wherein the TRNG circuit is configured to:
set transistors connected to a one of said one or more of the bitlines to an off state,
determine a time interval between different crossing thresholds in a voltage discharge in the one or more bitlines, and
digitize the time interval into bits of an TRNG output;
a physically unclonable function, PUF, circuit peripheral to the array of bitcells, with an input of the PUF circuit coupled to one or more pairs of bitlines;
wherein the PUF circuit is configured to:
set a pair of transistors connected to respective ones of the pair of bitlines and to the same wordline to an underdriven state,
determine respective times, t_{A}, t_{B}, of the transistors of the pair crossing a threshold in a voltage discharge in the pair of bitlines, and
digitize a difference between t_{A} and t_{B} into an n-bit PUF output, wherein n is an integer ≥2.

14. The SRAM structure of claim 13, wherein the TRNG circuit comprises a first column peripheral circuit for determining the time interval between the different crossing thresholds in the voltage discharge in the one or more bitlines and for digitizing the time interval into the bits of the TRNG output, and optionally wherein the first column peripheral circuit comprises a skewed inverter pair and a time-to-digital converter.

15. (canceled)

16. The SRAM structure of claim 14, wherein the first column peripheral comprises a voltage tuning loop to adjust a time-to-digital converter for digitizing the time interval for a substantially constant energy-per-bit conversion of the time interval into the bits of the TRNG output.

17. The SRAM structure of claim 13, wherein the TRNG circuit comprises a row decoder connected to the array of bitcells and to a global timing signal control block, and configured to set all wordlines to low level for setting the transistors connected to the bitlines to the off state.

18. The SRAM structure of claim 13, wherein the TRNG circuit is connected to the one or more bitlines via one or more column multiplexers.

19. The SRAM structure of claim 13, wherein the TRNG circuit is connected to the one or more bitlines bypassing one or more column multiplexers.

20. The SRAM structure of claim 13, wherein the input of the PUF circuit is coupled to a pair of bitlines directly, i.e., bypassing a column multiplexor.

21. The SRAM structure of claim 13, wherein the PUF circuit comprises a second column peripheral circuit for determining the respective times, t_{A}, t_{B}, and for digitizing the difference between t_{A} and t_{B} into the n-bit PUF output, and optionally wherein the second column peripheral circuit comprises a time difference arbiter circuit.

22. (canceled)

23. The SRAM structure of claim 13, wherein the PUF circuit comprises a row decoder connected to the array of bitcells and to a global timing signal control block, and configured to set the pair of transistors connected to the pair of bitlines and to the same wordline to the underdriven state.

24-27. (canceled)
